(19) United States
(12) Patent Application Publication
(10) Pub. No.: US 2006/0122868 A1
(43) Pub. Date: Jun. 8, 2006

(54) Systems, methods and apparatus for managing an infection prevention program

(75) Inventors: George William Curran, Sussex, WI (US); Chirag Suresh Barot, Waukesha, WI (US)

Correspondence Address: JAMES D IVEY, 3025 TOTTERDELL STREET, OAKLAND, CA, 94611-1742, US

(73) Assignee: General Electric Company, Schenectady, NY (US)

(21) Appl. No.: 11/002,816

(22) Filed: Dec. 2, 2004

(51) Int. Cl. G06F 19/00

(52) U.S. Cl. 705/3

(57) ABSTRACT

Systems, methods and apparatus are provided through which in some embodiments, a software system instructs a participant in a vaccination process when the participant should schedule medical appointments to receive vaccinations as a part of the process. In some embodiments, the software system tracks information submitted by the participant as to the date, and the physician's name and telephone number as required by governmental regulation. In some embodiments, if the participant fails to comply within the guidelines of the vaccination process, the software system notifies a medical department to invoke personal contact with the participant to answer questions of the participant or identify a reason for change in preference by the participant.

### FIELD OF THE INVENTION

This invention relates generally to medical regulatory compliance, and more particularly to managing administration of a communicable disease vaccination process.

### BACKGROUND OF THE INVENTION

Workers are often exposed to communicable diseases. Such workers include healthcare providers, first medical emergency responders, medical refurbishment technicians and medical equipment field engineers. This exposure is a well-known risk to workers. Communicable diseases include infectious communicable diseases. One category of infectious communicable diseases is bloodborne pathogens, such as pathogens that are carried in blood and/or saliva, which includes the Hepatitis B virus. Exposure to the communicable diseases by the workers can present a serious financial risk to an employer of the workers. At the very least, fear of exposure to the communicable diseases can hinder the productivity of the workers, but exposure may also present serious legal liability and public relations damage if the workers fall ill to the communicable diseases.

Accordingly, employers of the workers seek to help protect their employees who are at risk of exposure to communicable diseases. In some instances, the employers are required by law to help protect those employees from exposure. In one such instance, the U.S. Occupational Safety and Health Administration (OSHA) requires that all employees who are at risk of being exposed to blood-borne pathogens must be offered, and if accepted, receive Hepatitis B vaccination at the employer's expense. The employer is required to track the vaccination process that includes three shots and one blood test. The vaccination process must be tracked to completion for each employee at risk or until the employee signs a declination form stating that the employee no longer wishes to continue involvement in the vaccination process.

All conventional means of managing administration of a communicable disease vaccination process are manual systems that rely on paper to store information and that rely solely on humans to analyze data and report information. These manual systems suffer from a number of deficiencies, such as high cost for the manual labor, increased risk of error in recording and analyzing data, poor reporting ability and high risk of loss of information. These deficiencies increase the risk that the manual system will fail to some extent, which in turn can hinder the productivity of the workers, present serious legal liability and public relations damage if the employees fall ill to the communicable disease.

For the reasons stated above, and for other reasons stated below which will become apparent to those skilled in the art upon reading and understanding the present specification, there is a need in the art for a more cost effective and reliable system of managing administration of vaccination for a communicable disease in order to provide lower labor cost, lower risk of error in recording and analyzing vaccination process data, improved reporting ability and lower risk of loss of information.

### BRIEF DESCRIPTION OF THE INVENTION

The above-mentioned shortcomings, disadvantages and problems are addressed herein, which will be understood by reading and studying the following specification.

In some embodiments, a software system instructs a participant in a vaccination process as to when the participant should schedule medical appointments to receive vaccinations as a part of the process. In some embodiments, the software system tracks information submitted by the participant as to the date, and the physician's name and telephone number as required by governmental regulation. In some embodiments, if the participant fails to comply within the guidelines of the vaccination process, the software system notifies a medical department to invoke personal contact with the participant to answer questions of the participant or identify a reason for change in preference by the participant.

In one aspect, a first computer-accessible medium includes executable instructions to manage a communicable disease vaccination process, the executable instructions being capable of directing a processor to store data describing participation by an individual in a communicable disease vaccination process, and to analyze the data describing participation by the individual in the communicable disease vaccination process.

In another aspect, the first computer-accessible medium further includes executable instructions capable of directing a processor to access data describing participation by an individual in a communicable disease vaccination process, to determine compliance with the communicable disease vaccination process for the individual, to identify the current date and time being within a time period of at least one act of compliance in the communicable disease vaccination process for the individual, to generate a reminder email addressed to the individual, the reminder email comprising data describing the act of compliance, and to distribute the at least one reminder email through the Internet.

In yet another aspect, a second computer-accessible medium includes executable instructions to manage a communicable disease vaccination process, the executable instructions being capable of directing a processor to manage administration of at least one vaccination process, and to manage finalization of the at least one vaccination process.

In still another aspect, the executable instructions manage administration of at least one vaccination process further comprise executable instructions to invoke a first performance of a vaccination cycle for a communicable disease, to invoke a second performance of the vaccination cycle for a communicable disease about thirty days after the first performing, and to invoke a third performance of the vaccination cycle for a communicable disease about one-hundred-and-eighty days after the first performing.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram that provides a system level overview of a system to manage a communicable disease vaccination process;

FIG. 2 is a flowchart of a method of managing the vaccination process of a communicable disease according to an embodiment;

FIG. 3 is a flowchart of a method of initializing the vaccination process;

FIG. 4 is a flowchart of a method of entering data according to an embodiment in which the communicable disease is Hepatitis B;

FIG. 5 is a flowchart of a method of managing the vaccination cycle according to an embodiment;

FIG. 6 is a flowchart of a method of a vaccination cycle for Hepatitis B according to an embodiment;

FIG. 7 is a flowchart of a method of managing finalization according to an embodiment;

FIG. 8 is a flowchart of a method of managing vaccination compliance information according to an embodiment;

FIG. 9 is a block diagram of an apparatus to manage a communicable disease vaccination process according to an embodiment;

FIG. 10 is a block diagram of an apparatus to manage a blood-borne pathogens vaccination process in a client/server environment according to an embodiment;

FIG. 11 is a diagram of a data structure for use in managing a blood-borne pathogens vaccination process according to an embodiment; and

FIG. 12 is a block diagram of the hardware and operating environment in which different embodiments can be practiced.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, a system level overview is described. In the second section, methods of embodiments are described. In the third section, particular implementations are described. In the fourth section, the hardware and the operating environment in conjunction with which embodiments may be practiced are described. Finally, in the fifth section, a conclusion of the detailed description is provided.

### System Level Overview

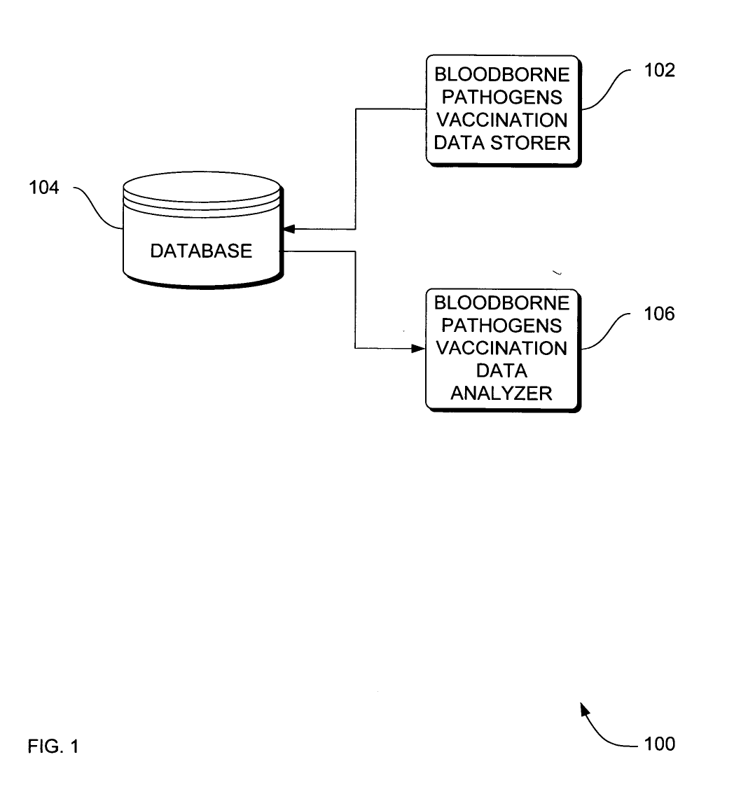

FIG. 1 is a block diagram that provides a system level overview of a system to manage a communicable disease vaccination process. System 100 solves the need in the art for a more cost effective and reliable system of managing administration of a communicable disease vaccination process.

System 100 includes a storer 102 of communicable disease vaccination process data that stores the data in a database 104. The storer 102 and the database provides an automated system of managing administration of a communicable disease vaccination process that in turn lowers labor costs of storing the data, lowers the risk of error in recording the data and lowers the risk of loss of the data.

System 100 also includes an analyzer 106 of the communicable disease vaccination process data. The automated process of the analyzer 106 lowers the risk of error in analyzing data which in turns improves reporting ability on the vaccination process data.

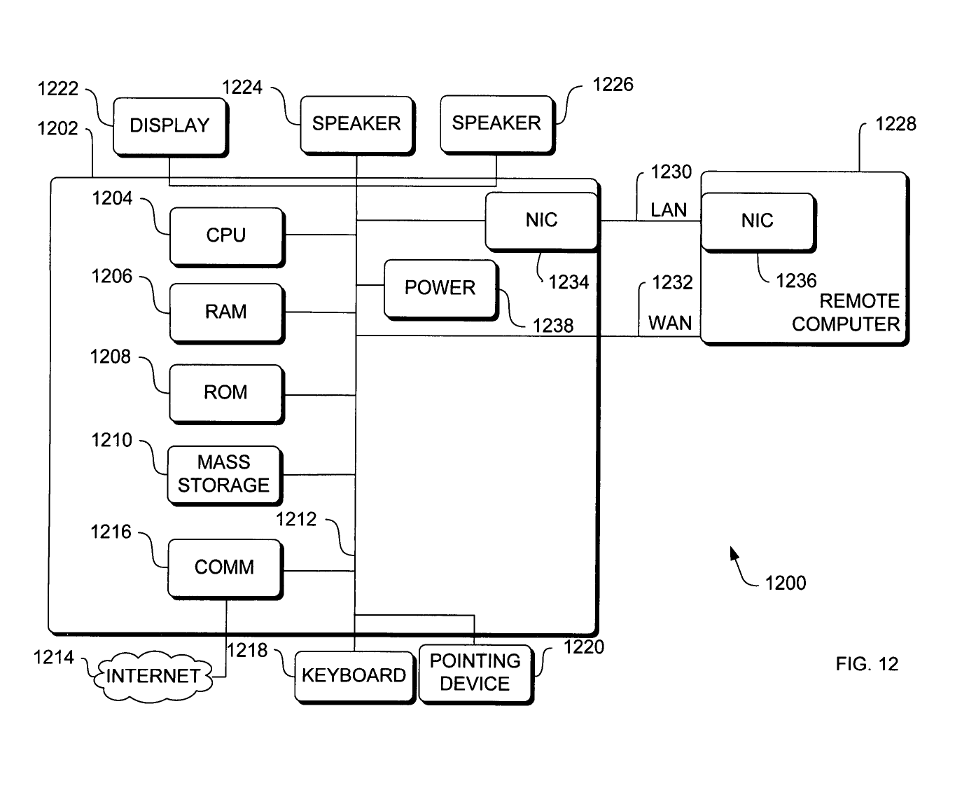

The system level overview of the operation of an embodiment has been described in this section of the detailed description. Embodiments operate in a multi-processing, multi-threaded operating environment on a computer, such as computer 1202 in FIG. 12.

While the system 100 is not limited to any particular storer 102, database 104 and analyzer 106, for sake of clarity a simplified storer 102, database 104 and analyzer 106 have been described. In other embodiments, the storer 102 and analyzer 106 are integrated into one component, or disintegrated into more components than as shown in FIG. 1.

System 100 reduces employer time in making telephone calls to verify compliance with the vaccination process by a participant as well as reduces time in charting data in medical records. System 100 tracks participation, which in turn allows quick access to data of individual participant or aggregation of participants. System 100 also reduces the risk of governmental fines for non-compliance of vaccination regulations.

### Methods of an Embodiment

In the previous section, a system level overview of the operation of an embodiment was described. In this section, the particular methods performed by computer of such an embodiment are described by reference to a series of flowcharts. Describing the methods by reference to a flowchart enables one skilled in the art to develop such programs, firmware, or hardware, including such instructions to carry out the methods on suitable computers, the processor of the computers executing the instructions from computer-readable media. Similarly, the methods performed by the computer programs, firmware, or hardware are also composed of computer-executable instructions. Methods 200-800 are performed by a program executing on, or performed by firmware or hardware that is a part of, a computer, such as computer 1202 in FIG. 12.

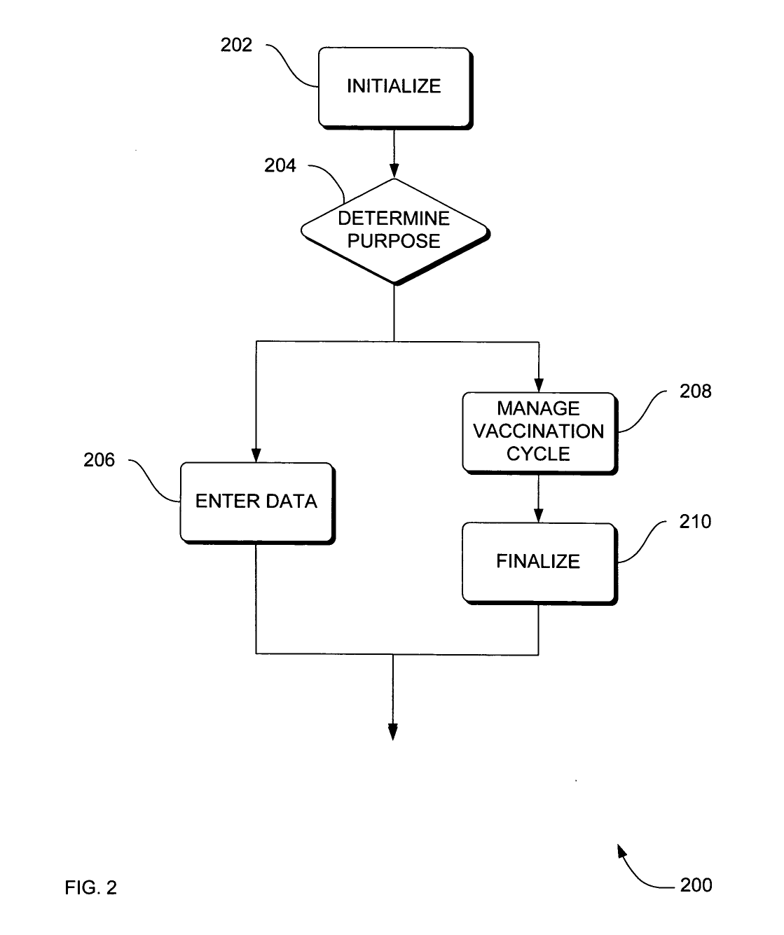

FIG. 2 is a flowchart of a method 200 of managing the vaccination process for a communicable disease according to an embodiment. Method 200 solves the need in the art for a more cost effective and reliable system of managing administration of vaccination for communicable disease.

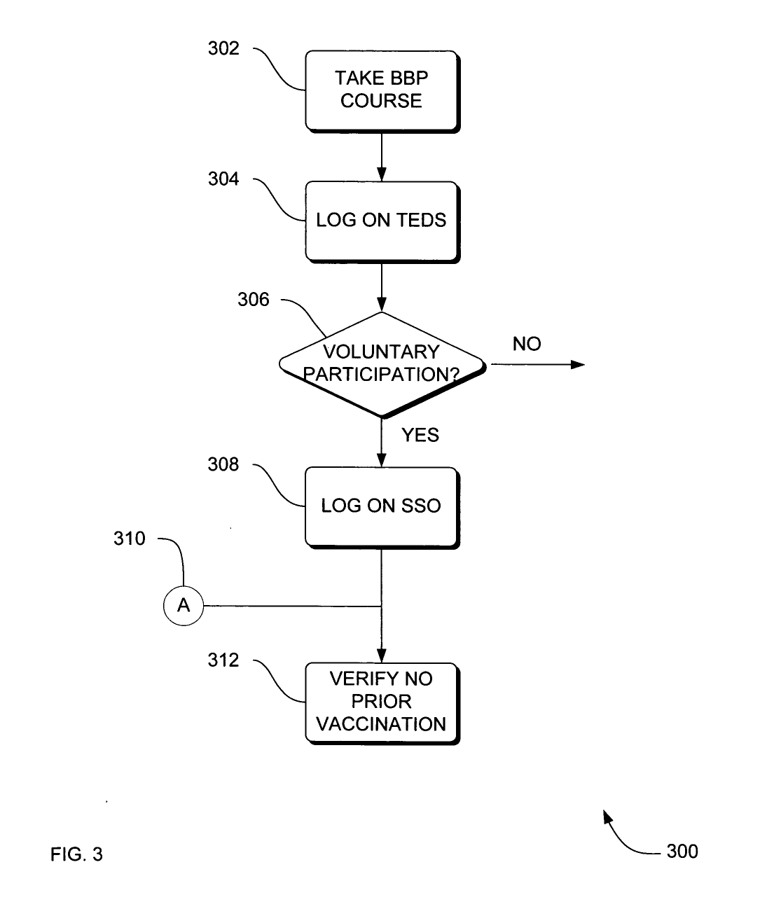

Method 200 includes initializing 202 the vaccination process. One embodiment of the initializing is shown in FIG. 3.

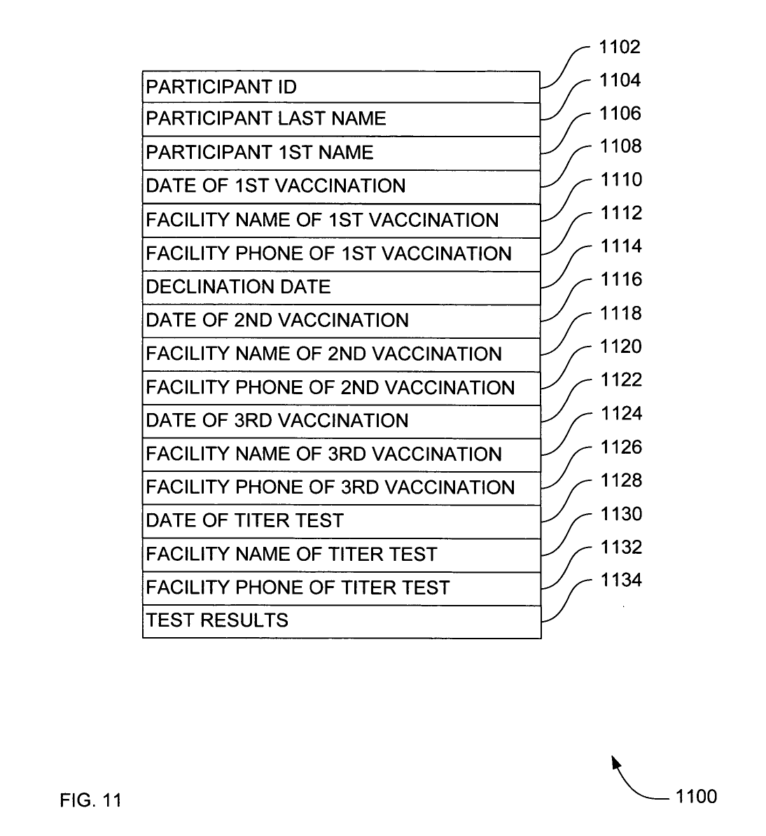

Method 200 thereafter includes determining 204 the purpose of performing method 200. If the purpose is to enter data, then entering 206 data pertaining to the vaccination process of one or more participants is performed, otherwise managing the vaccination cycle 208 and managing 210 finalization is performed. Examples of data pertaining to the vaccination process are describe in FIG. 11. Method 400 is one embodiment of entering data 206, method 500 is one embodiment of managing the vaccination cycle 208 and method 700 is one embodiment of managing finalization 210. The automated tasks of method 200 provide lower labor cost, lower risk of error in recording and analyzing vaccination process data, improved reporting ability and lower risk of loss of information.

As an alternative to a method of BBP vaccination in method 200, a testing process for tuberculosis infection of the participant is performed annually; the process including injection of a tuberculin and testing for tuberculosis 42-78 hours after the injection.

FIG. 3 is a flowchart of a method 300 of initializing the vaccination process. Method 300 is one embodiment of initializing 202 the vaccination process.

Method 300 includes receiving 302 communicable disease data of a participant. One example of a participant is field engineer that is at risk for exposure to one or more blood-borne pathogens.

Method 300 also includes logging 304 onto a web-based facility for testing competency.

Method 300 also includes determining 306 if the participation by the participant in the vaccination process is voluntary or not. If the participation is not voluntary, the method ends. If the participation is voluntary, thereafter the method includes logging 308 onto a system using a unique identification of the participant, which is often referred to as a single sign-on (SSO) system.

In some embodiments the method begins at point “A” 310.

Thereafter, the method includes verifying 312 that the participant has not previously completed a vaccination process for the communicable disease.

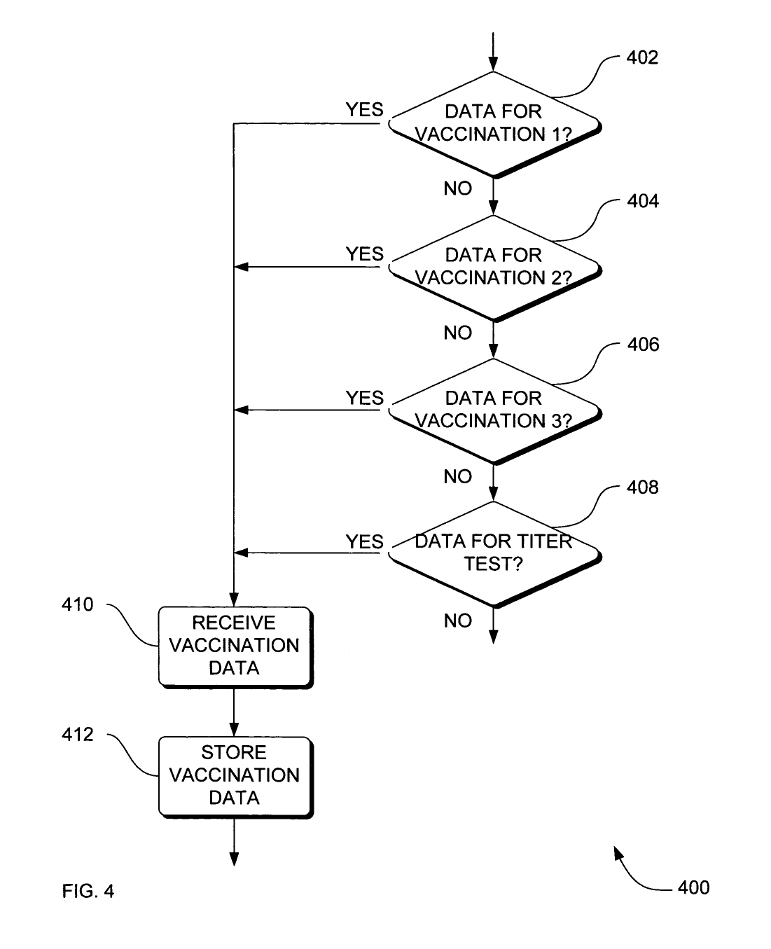

FIG. 4 is a flowchart of a method 400 of entering data according to an embodiment in which the communicable disease is Hepatitis B. Method 400 is one embodiment of entering data 206 in FIG. 2 in which vaccination details are updated.

Method 400 includes determining whether or not data for a first vaccination, a second vaccination, a third vaccination, or a titer test is to be entered in actions 402, 404, 406 and 408, respectively.

If data for a vaccination is determined to be entered, then the vaccination data is received 410 and stored 412. In some embodiments, the storing 412 is performed by the communicable disease vaccination data storer 102 in FIG. 1.

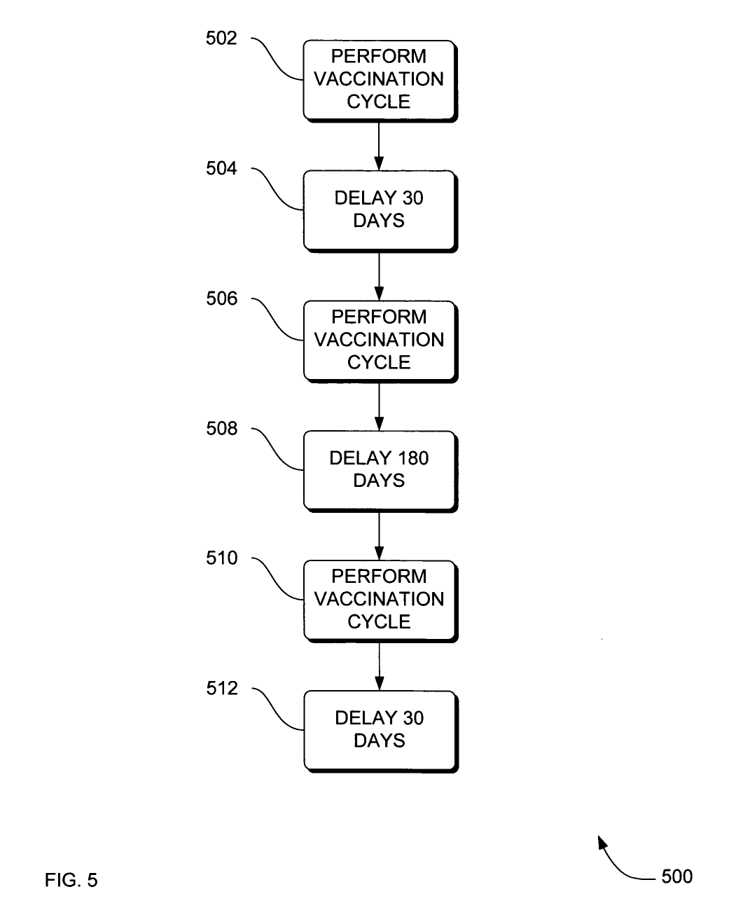

FIG. 5 is a flowchart of a method 500 of managing the vaccination cycle for Hepatitis B according to an embodiment. Method 500 is one embodiment of managing the vaccination cycle 208 in FIG. 2. Method 500 includes three vaccinations and one titer test.

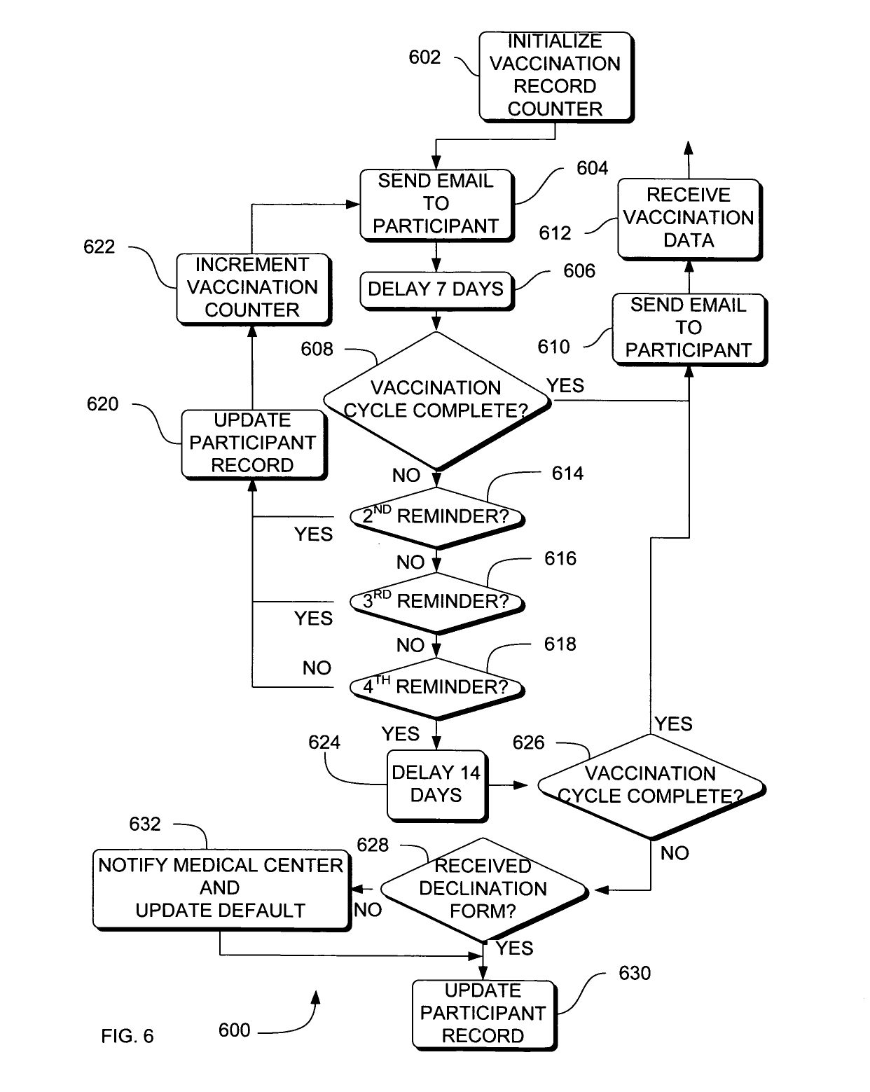

Method 500 includes performing 502 one vaccination cycle and then delaying 504 any further vaccinations for thirty days. One embodiment of the vaccination cycle is shown in FIG. 6.

Method 500 includes performing 506 one vaccination cycle and then delaying 508 any further vaccinations for one hundred and eighty days.

Method 500 includes performing 510 one vaccination cycle and then delaying 512 any further vaccinations for thirty days.

FIG. 6 is a flowchart of a method 600 of a vaccination cycle for Hepatitis B according to an embodiment. Method 600 is one embodiment of a vaccination cycle that is referenced in actions 502, 506 and 510 in method 500.

Method 600 includes initializing 602 a record counter of vaccinations. The counter stores the number of vaccinations in a performance of method 600.

Method 600 includes sending 604 email or some other form of communication to the participant requesting, prompting notifying and/or reminding the participant to obtain a vaccination. When a 3^{rd} or 4^{th} email communication is sent to the participant, the email includes a link to a web page that will allow the participant to approve a declination option. Thereafter, method 600 includes delaying 606 any other action for at least seven days.

Method 600 includes determining 608 whether or not the vaccination of the participant is complete, such as by inquiring with the participant as to whether or not the vaccination is complete, and/or accessing the medical records of the participant to determine if the vaccination of the participant is complete.

If the vaccination cycle is complete, performance of method 600 includes sending 610 an email of congratulations to the participant and receiving 612 vaccination data.

If the vaccination cycle is not complete, then performance of the method 600 includes determining 614 if a second email reminder has been sent to the participant, determining 616 if a third email has been sent to the participant and determining 616 if a fourth email has not been sent to the participant. If either determination is true, then the performance of method 600 progresses to updating 620 a record of the participant. In one embodiment of updating 620, details of the vaccination such as the number of the vaccination (e.g. 1, 2, or 3) in the series, the date of the vaccination, the name and/or social security number of the participant, and the name and phone number of the facility that performed the vaccination are added to a database, such as database 104 in FIG. 1. If either determination is true, the record counter of vaccinations is also incremented 622 and performance of method 600 continues with sending 604 email or some other form of communication to the participant.

If all determinations 614, 616 and 618 are false, then performance of the method 600 includes delaying 624 other action in method 600 for 14 days, and determining 626 whether or not the vaccination of the participant is complete, such as by inquiring with the participant as to whether or not the vaccination is complete, and/or accessing the medical records of the participant to determine to the vaccination of the participant is complete. If the vaccination cycle is complete, performance of method 600 includes sending 610 an email of congratulations to the participant and receiving 612 the vaccination data.

If the vaccination cycle is not complete, performance of the method 600 includes determining 628 if a declination form has been received from the participant and updating 630 a record of the participant. In one embodiment of updating 630, details of the vaccination such as the number of the vaccination (e.g. 1, 2, or 3) the date of the vaccination, the name and/or social security number of the participant, and the name and phone number of the facility that performed the vaccination are added to a database, such as database 104 in FIG. 1. If a declination form has not been received from the participant performance of the method 600 includes notifying 632 a medical center of the absence of the declination form of the participant and updating records to indicate that the participant has defaulted or failed in participation in the vaccination cycle.

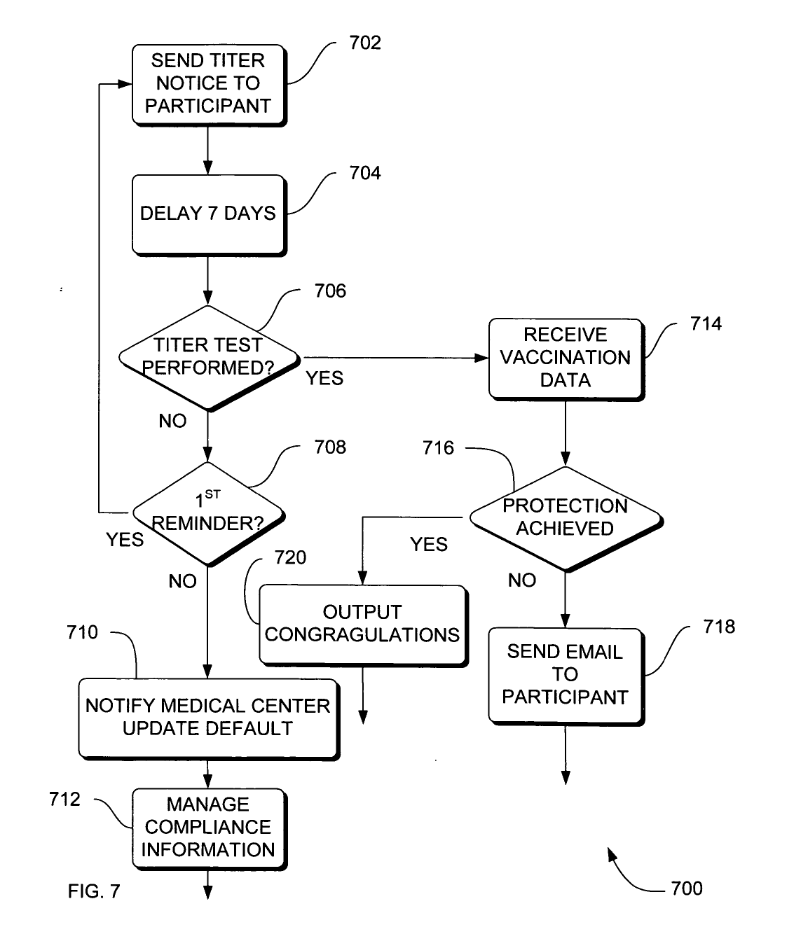

FIG. 7 is a flowchart of a method 700 of managing finalization according to an embodiment. Method 700 is one embodiment of managing finalization 210 in FIG. 2.

Method 700 includes sending 702 email or some other form of communication to the participant requesting, prompting and/or notifying the participant to obtain a blood test of the antibody to a communicable disease for which the participant is to be immunized, such as a communicable disease antibody test, delaying 704 other action in method 700, and then determining 706 whether or not the antibody test of the participant is complete.

If completion of the antibody test is not determined, performance of the method 700 includes determining 708 whether or not a first reminder of the antibody test has been sent to the participant.

If dispatch of the 1^{st} reminder is determined, performance of the method 700 returns to the action of sending 702 email or some other form of communication to the participant requesting, prompting and/or notifying the participant to obtain a communicable disease antibody test. If dispatch of the 1^{st} reminder is not determined, performance of the method 700 includes in some embodiments, notifying 710 a medical center of the absence of the declination form of the participant and in some embodiments, updating records to indicate that the participant has defaulted or failed in participation in the vaccination cycle and managing 712 vaccination compliance information. One embodiment of managing vaccination compliance information 712 is described in method 8 below.

If completion of the communicable disease antibody test is determined to have occurred, performance of the method 700 includes receiving 714 vaccination data of the participant and determining 716 whether or not protection from the vaccinated pathogens has been achieved in the participant.

If protection from the communicable disease has not been achieved, performance of method 700 includes sending 718 an email to the participant requesting the participant to contact the medical center for additional information and directing the participant to restart their vaccination process at step “A.” If protection from the communicable disease has been achieved, performance of the method 700 includes displaying a message of congratulations in a pop-up window and displaying a printable version of data 720.

In some embodiments, methods 200-800 are implemented as a computer data signal embodied in a carrier wave, that represents a sequence of instructions which, when executed by a processor, such as processor 1204 in FIG. 12, cause the processor to perform the respective method. In other embodiments, methods 200-800 are implemented as a computer-accessible medium having executable instructions capable of directing a processor, such as processor 1204 in FIG. 12, to perform the respective method. In varying embodiments, the medium is a magnetic medium, an electronic medium, or an optical medium.

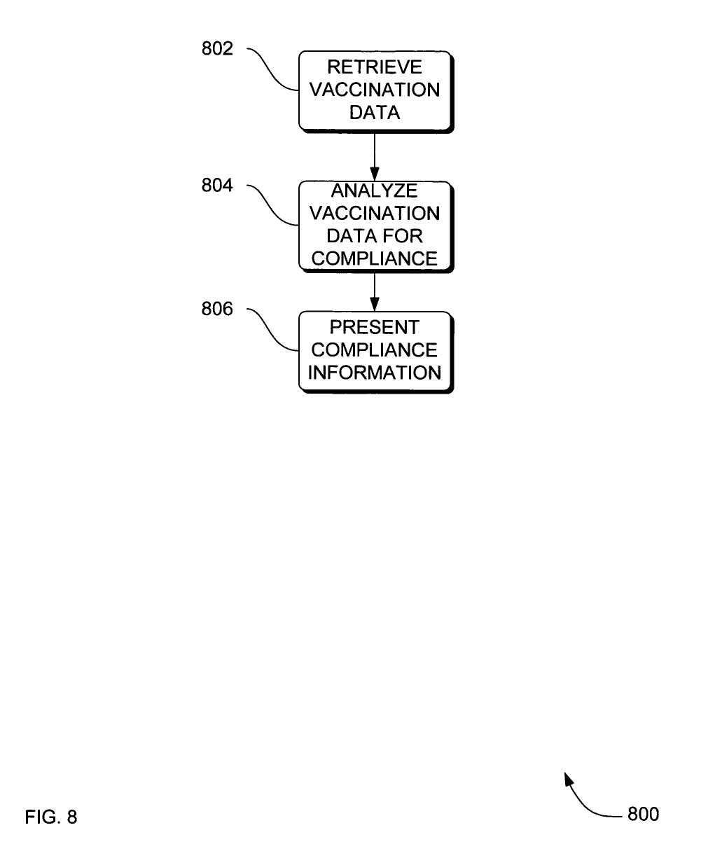

FIG. 8 is a flowchart of a method 800 of managing vaccination compliance information according to an embodiment. Method 800 is one embodiment of managing vaccination compliance information 712 in FIG. 7.

Method 800 includes retrieving vaccination data 802, such as retrieving vaccination data from database 104 in FIG. 1.

Method 800 thereafter includes analyzing 804 the vaccination data to determine compliance with one or more requirements of regulation on vaccination processes. In some examples, the requirements are imposed by the employer of the participant, or other examples the regulation is imposed by a governmental organization such as the U.S. Occupational Safety and Health Administration (OSHA). In some embodiments, action 804 is performed by a compliance analyzer 906 in FIG. 900.

Subsequently, method 800 includes presenting 806 the compliance information. In some embodiments, presenting 806 includes presenting data that is suitable for demonstrating compliance with at least one OSHA vaccination regulation and/or compliance with at least one employer vaccination requirements. In various embodiments, presenting can be printing a report, generating and dispatching an email and/or displaying the compliance information on a computer screen.

### Implementation

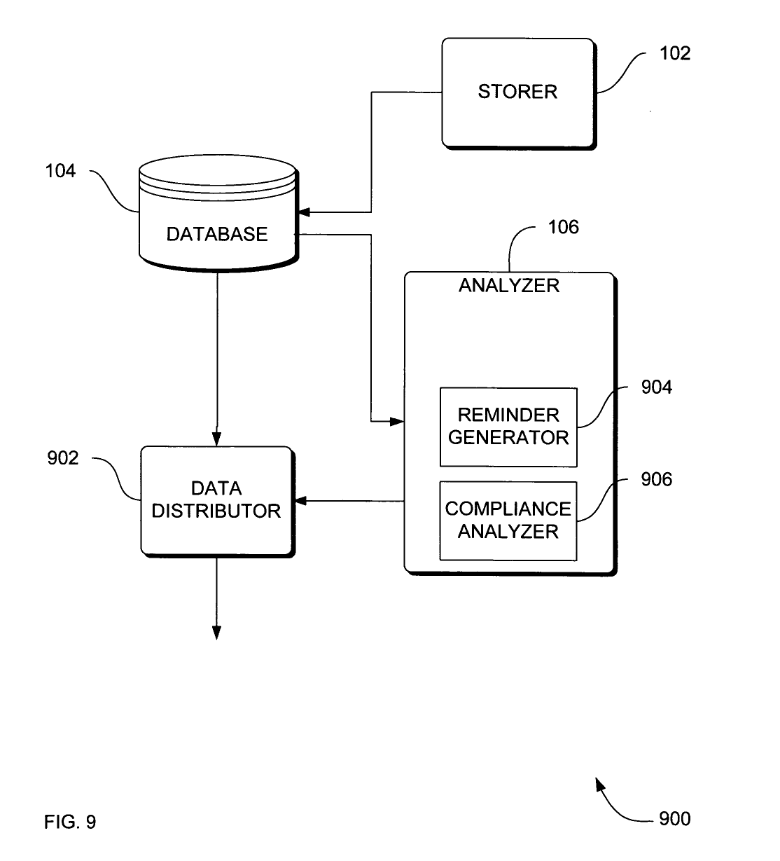

Referring to FIGS. 9-11, particular implementations are described in conjunction with the system overview in FIG. 1 and the methods described in conjunction with FIGS. 2-8.

FIG. 9 is a block diagram of an apparatus 900 to manage a communicable disease vaccination process according to an embodiment. Apparatus 900 solves the need in the art for a more cost effective and reliable system of managing administration of vaccination for communicable disease.

Apparatus 900 includes a data distributor 902. In some embodiments, the data distributor 902 distributes data analyzed by the communicable disease vaccination process analyzer 106. The data describes participation by the participant in the communicable disease vaccination process. In some embodiments, the data distributor 902 queries the database 104 for information such as the dates of vaccinations for individual participants or aggregations of participants, of either participants who are still involved in the vaccine cycle process, or participants that are not involved in the vaccine cycle process.

In some embodiments, the communicable disease vaccination process analyzer 106 includes a reminder generator 904. The reminder generator 904 identifies the current date and time as being within a time period to provide at least one reminder of at least one act of compliance in the communicable disease vaccination process for an individual participant.

In some embodiments, the communicable disease vaccination process analyzer 106 includes a compliance analyzer 906. The compliance analyzer 906 determines compliance of one or more individual participants with one or more government-required communicable disease vaccination processes. For example, the U.S. Department of Labor Occupational Safety & Health Administration (OSHA) is one governmental organization that regulates, monitors and in some scenarios, requires blood-borne pathogen vaccinations for employers of employees who are at risk of being exposed to blood-borne pathogens, such as Hepatitis B. In some embodiments, compliance includes one or more vaccinations and/or one or blood tests. In some embodiments, the compliance analyzer performs analyzing 804 the vaccination data to determine compliance with one or more requirements or regulation on vaccination processes, in FIG. 8 above.

The automated components of apparatus 1000 provide lower labor cost, lower risk of error in recording and analyzing vaccination process data, improved reporting ability and lower risk of loss of information.

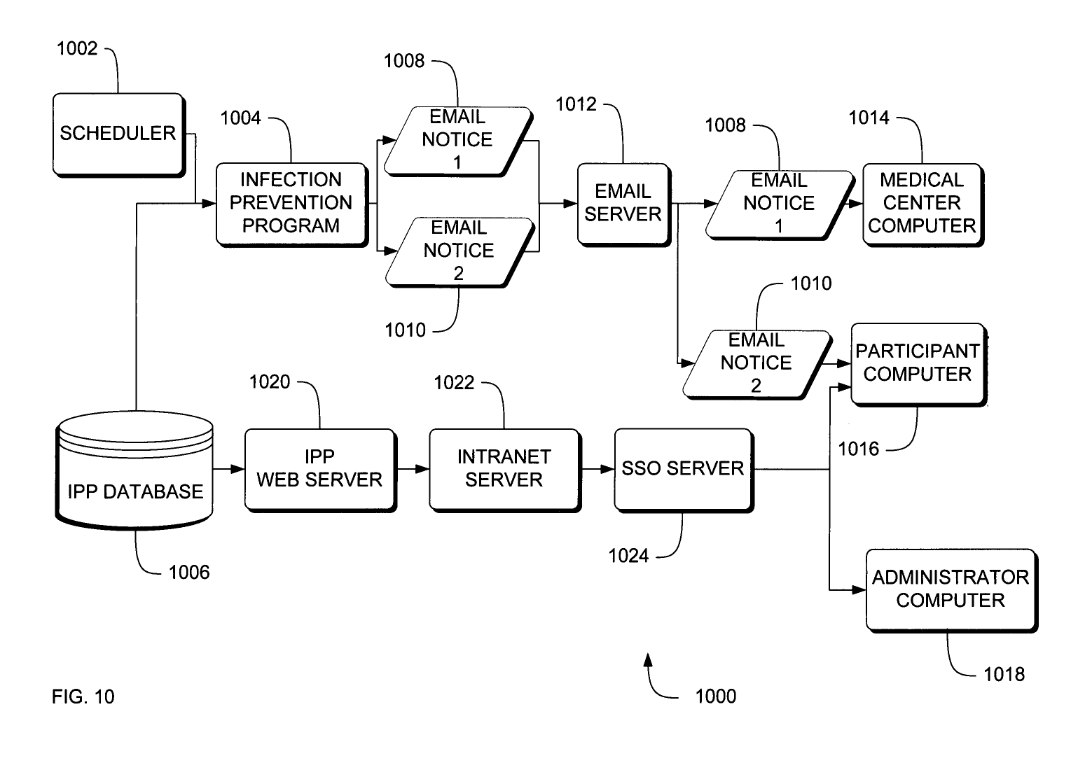

FIG. 10 is a block diagram of an apparatus 1000 to manage a blood-borne pathogens vaccination process in a client/server environment according to an embodiment.

Apparatus 1000 includes a scheduler 1002 that sends schedule data to an infection prevention program (IPP) 1004. One example of schedule data is data indicating delays between vaccinations and before a titer test. In some embodiments, IPP 1004 performs methods 200-800.

System 1000 also includes an IPP database 1006 that sends data to the IPP 1004. In one embodiment, the IPP database 1006 includes records of the data structure 1100 described below.

The IPP 1004, among other tasks, analyzes the schedule and generates email reminder notices Email Notice-1 1008 and Email Notice-2 1010. In some embodiments Email Notice-1 1008 is addressed to a medical center that is involved in administering one of more of the vaccinations in the vaccination process. Email Notice-2 1010 is addressed to the participant. The email reminder notices 1008 and 1010 are transmitted from the IPP 1004 to an email server 1012.

In some embodiments, the email server 1012 transmits the email reminder notices 1008 via the Internet (not shown) to a computer 1014 that is associated with the medical center that is involved in administering one of more of the vaccinations in the vaccination process. In some embodiments, computer 1014 is computer 1202.

The email server 1012 also transmits the email reminder notice 1010 via the Internet to a computer 1016 associated with the participant. In some embodiments, computer 1016 is computer 1202.

The participant computer 1016 and a computer 1018 associated with an administrator of the communicable disease vaccination process. The participant computer 1016 and the administrator computer 1018 are operatively coupled to the IPP database 1006 and communicate through client/server protocols. The participant computer 1016 and the administrator computer 1018 query the IPP database 1006 through a number of computing devices that support client/server communication that are operatively coupled to each other, such as webserver 1020, an intranet server 1022 and a single-sign-on (SSO) server 1024. In some embodiments, computer 1018 is computer 1202.

Apparatus 900 components of the storer 102, the data distributor 902, the reminder generator 904, the compliance analyzer 906, scheduler 1002 and/or IPP 1004, can be embodied as computer hardware circuitry or as a computer-readable program, or a combination of both. In some embodiments, apparatus 900 and 1000 are implemented in an application service provider (ASP) system.

More specifically, in the computer-readable program embodiment, the programs can be structured in an object-orientated methodology using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 1202 in FIG. 12, or on at least as many computers as there are components. The software development tools and techniques described in the development of software of systems, method and apparatus for managing an infection prevention program are not exhaustive. Other tools and technologies may be implemented new technologies are introduced.

FIG. 11 is a diagram of a data structure 1100 for use in managing a communicable disease vaccination process according to an embodiment. In one embodiment, data structure 1100 is implemented in database 104 in FIG. 1.

Data structure 1100 solves the need in the art for a more cost effective and reliable system of managing administration of a communicable disease vaccination process. Data structure 1100 tracks participation in a communicable disease vaccination process, which in turn allows quick access to data of each individual participant or aggregation of participants. Data structure 1100 also reduces the risk of governmental fines for non-compliance with vaccination regulations.

Data structure 1100 includes locations to store data representing or pointing to a unique identifier of a participant 1102, a last name 1104 and a first name 1106 of the participant in the vaccination process. These data fields allow each instance of the data structure 1100 to be associated with the vaccination data that follows.

Data structure 1100 includes locations to store data representing or pointing to a date 1108 and a name 1110 and a phone number 1112 of a medical facility and/or physician of which the first vaccination was performed.

Data structure 1100 includes locations to store data representing or pointing to a date 1114 of declination of participation in the vaccination process.

Data structure 1100 includes locations to store data representing or pointing to a date 1116 and a name 1118 and a phone number 1120 of a medical facility and/or physician of which the second vaccination was performed.

Data structure 1100 includes locations to store data representing or pointing to a date 1122 and a name 1124 and a phone number 1126 of a medical facility and/or physician of which the third vaccination was performed.

Data structure 1100 includes locations to store data representing or pointing to a date 1128 and a name 1130 and a phone number 1132 of a medical facility and/or physician of which a titer test was performed.

Data structure 1100 includes locations to store data representing or pointing to at least one test result 1134 of vaccination protection from the communicable disease of interest in the vaccination process.

### Hardware and Operating Environment

FIG. 12 is a block diagram of the hardware and operating environment 1200 in which different embodiments can be practiced. The description of FIG. 12 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 1202 includes a processor 1204, commercially available from Intel, Motorola, Cyrix and others. Computer 1202 also includes random-access memory (RAM) 1206, read-only memory (ROM) 1208, and one or more mass storage devices 1210, and a system bus 1212, that operatively couples various system components to the processing unit 1204. The memory 1206, 1208, and mass storage devices, 1210, are types of computer-accessible media. Mass storage devices 1210 are more specifically types of nonvolatile computer-accessible media and can include one or more hard disk drives, floppy disk drives, optical disk drives, and tape cartridge drives. The processor 1204 executes computer programs stored on the computer-accessible media.

Computer 1202 can be communicatively connected to the Internet 1214 via a communication device 1216. Internet 1214 connectivity is well known within the art. In one embodiment, a communication device 1216 is a modem that responds to communication drivers to connect to the Internet via what is known in the art as a “dial-up connection.” In another embodiment, a communication device 1216 is an Ethernet® or similar hardware network card connected to a local-area network (LAN) that itself is connected to the Internet via what is known in the art as a “direct connection” (e.g., T1 line, etc.).

A user enters commands and information into the computer 1202 through input devices such as a keyboard 1218 or a pointing device 1220. The keyboard 1218 permits entry of textual information into computer 1202, as known within the art, and embodiments are not limited to any particular type of keyboard. Pointing device 1220 permits the control of the screen pointer provided by a graphical user interface (GUI) of operating systems such as versions of Microsoft Windows®. Embodiments are not limited to any particular pointing device 1220. Such pointing devices include mice, touch pads, trackballs, remote controls and point sticks. Other input devices (not shown) can include a microphone, joystick, game pad, satellite dish, scanner, or the like.

In some embodiments, computer 1202 is operatively coupled to a display device 1222. Display device 1222 is connected to the system bus 1212. Display device 1222 permits the display of information, including computer, video and other information, for viewing by a user of the computer. Embodiments are not limited to any particular display device 1222. Such display devices include cathode ray tube (CRT) displays (monitors), as well as flat panel displays such as liquid crystal displays (LCD's). In addition to a monitor, computers typically include other peripheral input/output devices such as printers (not shown). Speakers 1224 and 1226 provide audio output of signals. Speakers 1224 and 1226 are also connected to the system bus 1212.

Computer 1202 also includes an operating system (not shown) that is stored on the computer-accessible media RAM 1206, ROM 1208, and mass storage device 1210, and is and executed by the processor 1204. Examples of operating systems include Microsoft Windows®, Apple MacOS®, Linux®, UNIX®. Examples are not limited to any particular operating system, however, and the construction and use of such operating systems are well known within the art.

Embodiments of computer 1202 are not limited to any type of computer 1202. In varying embodiments, computer 1202 comprises a PC-compatible computer, a MacOS®-compatible computer, a Linux®-compatible computer, or a UNIX®-compatible computer. The construction and operation of such computers are well known within the art.

Computer 1202 can be operated using at least one operating system to provide a graphical user interface (GUI) including a user-controllable pointer. Computer 1202 can have at least one web browser application program executing within at least one operating system, to permit users of computer 1202 to access an intranet, extranet or Internet world-wide-web pages as addressed by Universal Resource Locator (URL) addresses. Examples of browser application programs include Netscape Navigator® and Microsoft Internet Explorer®.

The computer 1202 can operate in a networked environment using logical connections to one or more remote computers, such as remote computer 1228. These logical connections are achieved by a communication device coupled to, or a part of, the computer 1202. Embodiments are not limited to a particular type of communications device. The remote computer 1228 can be another computer, a server, a router, a network PC, a client, a peer device or other common network node. The logical connections depicted in FIG. 12 include a local-area network (LAN) 1230 and a wide-area network (WAN) 1232. Such networking environments are commonplace in offices, enterprise-wide computer networks, intranets, extranets and the Internet.

When used in a LAN-networking environment, the computer 1202 and remote computer 1228 are connected to the local network 1230 through network interfaces or adapters 1234, which is one type of communications device 1216. Remote computer 1228 also includes a network device 1236. When used in a conventional WAN-networking environment, the computer 1202 and remote computer 1228 communicate with a WAN 1232 through modems (not shown). The modem, which can be internal or external, is connected to the system bus 1212. In a networked environment, program modules depicted relative to the computer 1202, or portions thereof, can be stored in the remote computer 1228.

Computer 1202 also includes power supply 1238. Each power supply can be a battery.

### CONCLUSION

An infection prevention program has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application with respect to client server protocols is meant to include all database and communication environments and alternate technologies which provide the same functionality as described herein.

We claim:

1. A computer-accessible medium having executable instructions to manage a communicable disease vaccination process, the executable instructions capable of directing a processor to perform:
storing data describing participation by an individual in a communicable disease vaccination process; and
analyzing the data describing participation by the individual in the communicable disease vaccination process.

2. The computer-accessible medium of claim 1, the medium further comprising executable instructions capable of directing a processor to perform:
distributing the analyzed data describing participation by the individual in the communicable disease vaccination process.

3. The computer-accessible medium of claim 1, wherein the analyzing further comprises:
identifying the current date and time being within a time period to provide at least one reminder of at least one act of compliance in the communicable disease vaccination process for the individual; and
determining compliance with the communicable disease vaccination process for the individual.

4. The computer-accessible medium of claim 3, wherein the at least one act of compliance further comprises:
at least one vaccination.

5. The computer-accessible medium of claim 3, wherein the at least one act of compliance further comprises:
at least one blood test.

6. The computer-accessible medium of claim 1, wherein the communicable disease further comprises:
Hepatitis B virus.

7. A computer-accessible medium having executable instructions to manage a blood-borne pathogens vaccination process, the executable instructions capable of directing a processor to perform:
accessing data describing participation by an individual in a blood-borne pathogens vaccination process;
determining compliance with the blood-borne pathogens vaccination process for the individual;
identifying the current date and time being within a time period of at least one act of compliance in the blood-borne pathogens vaccination process for the individual;
generating a reminder email addressed to the individual, the reminder email comprising data describing the act of compliance; and
distributing the at least one reminder email through the Internet.

8. The computer-accessible medium of claim 7, wherein the at least one act of compliance further comprises:
at least one vaccination.

9. The computer-accessible medium of claim 7, wherein the at least one act of compliance further comprises:
at least one blood test.

10. The computer-accessible medium of claim 7, wherein the blood-borne pathogens further comprises:
Hepatitis B virus.

11. A computer-accessible medium having executable instructions to manage a Hepatitis B virus vaccination cycle of an employee that is required to be managed by an employer of the employee, the executable instructions capable of directing a processor to perform:
accessing data describing participation by the employee in Hepatitis B virus vaccination cycle that is required by an organization;
determining compliance with the Hepatitis B virus vaccination cycle of the employee;
generating a reminder email addressed to the employee, the reminder email comprising data describing an act of compliance; and
distributing the at least one reminder email through the Internet.

12. The computer-accessible medium of claim 11, wherein the act of compliance further comprises:
at least one blood test.

13. The computer-accessible medium of claim 11, wherein the organization further comprises:
the U.S. Occupational Safety and Health Administration.

14. A computer-accessible medium having executable instructions capable to manage a vaccination process, the executable instructions capable of directing a processor to perform:
managing administration of at least one vaccination process; and
managing finalization of the at least one vaccination process.

15. The computer-accessible medium of claim 14, wherein managing administration of at least one vaccination process further comprises:
a first performing of a vaccination cycle for a blood-borne pathogen;
a second performing of the vaccination cycle for a blood-borne pathogen about thirty days after the first performing; and
a third performing of the vaccination cycle for a blood-borne pathogen about one-hundred-and-eighty days after the first performing.

16. The computer-accessible medium of claim 15, wherein the vaccination cycle for a blood-borne pathogen further comprises:
sending a email reminder to a participant in the vaccination process describing the vaccination;
determining whether or not this vaccination cycle is complete if the fourth email reminder is determined to have been sent;
receiving vaccination data if the vaccination cycle is determined to be complete; and
updating a record associated with the participant.

17. The computer-accessible medium of claim 16, wherein the blood-borne pathogen further comprises:
Hepatitis B virus.

18. The computer-accessible medium of claim 15, wherein the vaccination cycle for a blood-borne pathogen further comprises:
initializing a vaccination counter to zero;
sending a email reminder to a participant in the vaccination process describing the vaccination;
determining whether or not this vaccination cycle is complete, seven days after the sending;
receiving vaccination data if the vaccination cycle is determined to be complete;
determining if a second and a third email reminder have been sent if the vaccination cycle is determined to be not complete;
updating a record associated with the participant if the second and a third email reminder are determined to have been sent;
attaching a declination option if the second and a third email reminder are determined to have been sent;
incrementing the vaccination counter if the second and a third email reminder are determined to have been sent;
determining if a fourth email reminder has been sent if the second and a third email reminder are determined to not have been sent;
sending an email reminder to the participant in the vaccination process if the fourth email reminder is determined to have been sent;
determining whether or not this vaccination cycle is complete if the fourth email reminder is determined to have been sent;
receiving vaccination data if the vaccination cycle is determined to be complete;
determining whether or not the declination form has been received if the vaccination cycle is determined to not be complete;
notifying a medical center if the declination form is determined to have not been received;
updating records to indicate that the participant has defaulted or failed in participation in the vaccination cycle if the declination form is determined to have not been received; and
updating a record associated with the participant after determining whether or not the declination form has been received.

19. The computer-accessible medium of claim 14, wherein managing finalization of at least one vaccination process further comprises:
sending a titer notice to a participant of at least one of the vaccination process
determining whether or not the titer test was performed, the determining being performed seven days after the sending;
determining of the first titer notice has been sent, if the titer test is not determined to have been performed;
continuing performance of managing finalization at the sending action, if the first titer notice is determined to have been sent;
updating records to indicate that the participant has defaulted or failed in participation in the vaccination cycle if the first titer notice is not determined to have been sent;
updating a record associated with the participant if the first titer notice is not determined to have been sent;
receiving vaccination data if the titer test is determined to have been performed;
determining if biological protection against a blood-borne pathogen exists in the participant;
sending a declination form, if the biological protection is not determined to exist in the participant;
sending a declination form, if the biological protection is not determined to exist in the participant;
updating records to indicate that the participant has defaulted or failed in participation in the vaccination cycle if the biological protection is determined to exist in the participant; and
updating a record associated with the participant if the biological protection is determined to exist in the participant.

20. The computer-accessible medium of claim 14, wherein the at least one vaccination cycle further comprises:
four cycles.

21. The computer-accessible medium of claim 14, wherein the blood-borne pathogen further comprises:
Hepatitis B virus.

22. The computer-accessible medium of claim 14, wherein the at least one vaccination process further comprises:
three vaccinations for Hepatitis B virus; and
one titer test.

23. The computer-accessible medium of claim 14, wherein the at least one vaccination process further consists of:
three vaccinations for Hepatitis B virus; and
one titer test.

24. The computer-accessible medium of claim 14, wherein the computer-accessible medium further comprises:
entering data pertaining to the vaccination process of one or more participants.

25. The computer-accessible medium of claim 24, wherein entering data pertaining to the vaccination process of one or more participants further comprises:
determining that data for one of the vaccinations of one of the at least one vaccination process is to be entered;
receiving the data; and
storing the data in a non-volatile storage medium.

26. A computer-accessible medium having executable instructions capable to manage a Hepatitis B virus vaccination process, the executable instructions capable of directing a processor to perform:
a first performing of a vaccination cycle for a Hepatitis B virus;
a second performing of the vaccination cycle for a blood-borne pathogen about thirty days after the first performing;
a third performing of the vaccination cycle for the Hepatitis B virus about one-hundred-and-eighty days after the first performing; and
managing finalization of the at least one Hepatitis B virus vaccination process.

27. The computer-accessible medium of claim 26, wherein the vaccination cycle for a blood-borne pathogen further comprises:
sending a email reminder to a participant in the Hepatitis B virus vaccination process describing the vaccination;
determining whether or not this vaccination cycle is complete if the fourth email reminder is determined to have been sent;
receiving vaccination data if the vaccination cycle is determined to be complete; and
updating a record associated with the participant.

28. The computer-accessible medium of claim 26, wherein the computer-accessible medium further comprises:
entering data pertaining to the Hepatitis B virus vaccination process of one or more participants.

29. The computer-accessible medium of claim 28, wherein entering data pertaining to the Hepatitis B virus vaccination process of one or more participants further comprises:
determining that data for one of the vaccinations of one of the at least one Hepatitis B virus vaccination process is to be entered;
receiving the data; and
storing the data in a non-volatile storage medium.

30. A method to manage a vaccination process comprising:
managing administration of at least one vaccination process; and
managing finalization of the at least one vaccination process.

31. The method of claim 30, wherein managing administration of at least one vaccination process further comprises:
a first performing of a vaccination cycle for a blood-borne pathogen;
a second performing of the vaccination cycle for a blood-borne pathogen about thirty days after the first performing; and
a third performing of the vaccination cycle for a blood-borne pathogen about one-hundred-and-eighty days after the first performing.

32. The method of claim 31, wherein the vaccination cycle for a blood-borne pathogen further comprises:
sending a email reminder to a participant in the vaccination process describing the vaccination;
determining whether or not this vaccination cycle is complete if the fourth email reminder is determined to have been sent;
receiving vaccination data if the vaccination cycle is determined to be complete; and
updating a record associated with the participant.

33. The method of claim 31, wherein the blood-borne pathogen further comprises:
Hepatitis B virus.

34. The method of claim 31, wherein the vaccination cycle for a blood-borne pathogen further comprises:
initializing a vaccination counter to zero;
sending a email reminder to a participant in the vaccination process describing the vaccination;
determining whether or not this vaccination cycle is complete, seven days after the sending;
receiving vaccination data if the vaccination cycle is determined to be complete;
determining if a second and a third email reminder have been sent if the vaccination cycle is determined to be not complete;
updating a record associated with the participant if the second and a third email reminder are determined to have been sent;
attaching a declination option if the second and a third email reminder are determined to have been sent;
incrementing the vaccination counter if the second and a third email reminder are determined to have been sent;
determining if a fourth email reminder has been sent if the second and a third email reminder are determined to not have been sent;
sending an email reminder to the participant in the vaccination process if the fourth email reminder is determined to have been sent;
determining whether or not this vaccination cycle is complete if the fourth email reminder is determined to have been sent;
receiving vaccination data if the vaccination cycle is determined to be complete;
determining whether or not the declination form has been received if the vaccination cycle is determined to not be complete;
notifying a medical center if the declination form is determined to have not been received;
updating records to indicate that the participant has defaulted or failed in participation in the vaccination cycle if the declination form is determined to have not been received; and
updating a record associated with the participant after determining whether or not the declination form has been received.

35. The method of claim 30, wherein managing finalization of at least one vaccination process further comprises:
sending a titer notice to a participant of at least one of the vaccination process
determining whether or not the titer test was performed, the determining being performed seven days after the sending;
determining of the first titer notice has been sent, if the titer test is not determined to have been performed;
continuing performance of managing finalization at the sending action, if the first titer notice is determined to have been sent;
updating records to indicate that the participant has defaulted or failed in participation in the vaccination cycle if the first titer notice is not determined to have been sent;
updating a record associated with the participant if the first titer notice is not determined to have been sent;
receiving vaccination data if the titer test is determined to have been performed;
determining if biological protection against a blood-borne pathogen exists in the participant;
sending a declination form, if the biological protection is not determined to exist in the participant;
sending a declination form, if the biological protection is not determined to exist in the participant;
updating records to indicate that the participant has defaulted or failed in participation in the vaccination cycle if the biological protection is determined to exist in the participant; and
updating a record associated with the participant if the biological protection is determined to exist in the participant.

36. The method of claim 30, wherein the at least one vaccination cycle further comprises:
four cycles.

37. The method of claim 30, wherein the blood-borne pathogen further comprises:
Hepatitis B virus.

38. The method of claim 30, wherein the at least one vaccination process further comprises:
three vaccinations for Hepatitis B virus; and
one titer test.

39. The method of claim 30, wherein the at least one vaccination process further consists of:
three vaccinations for Hepatitis B virus; and
one titer test.

40. The method of claim 30, wherein the method further comprises:
entering data pertaining to the vaccination process of one or more participants.

41. The method of claim 40, wherein entering data pertaining to the vaccination process of one or more participants further comprises:
determining that data for one of the vaccinations of one of the at least one vaccination process is to be entered;
receiving the data; and
storing the data in a non-volatile storage medium.

42. A computer-accessible medium having executable instructions capable to manage vaccination compliance, the executable instructions capable of directing a processor to perform:
retrieving vaccination data;
analyzing the vaccination data to determine compliance with one or more requirements or regulation on vaccination processes; and
presenting the compliance information.

43. The computer-accessible medium of claim 42, wherein the regulation further comprises:
U.S. Occupational Safety and Health Administration regulation.

44. The computer-accessible medium of claim 42, wherein the presenting further comprises:
presenting data that is suitable for demonstrating compliance with at least one OSHA vaccination regulation.

45. The computer-accessible medium of claim 42, wherein the presenting further comprises:
presenting data that is suitable for demonstrating compliance with at least one employer vaccination requirements.

46. A computer-accessible medium to manage administration of a blood-borne pathogen vaccination process, the medium comprising:
a storer of blood-borne pathogens vaccination process data to a database; and
an analyzer of the blood-borne pathogens vaccination process data from the database.

47. The computer-accessible medium of claim 46 wherein the medium further comprises:
a data distributor of data was analyzed by the blood-borne pathogens vaccination process analyzer.

48. The computer-accessible medium of claim 46, wherein the medium further comprises:
a generator of at least one reminder, the generator operable to identify the current date and time as being within a time period to provide at least one reminder of at least one act of compliance in the blood-borne pathogens vaccination process for an individual participant in the process.

49. The computer-accessible medium of claim 46, wherein the medium further comprises:
a compliance analyzer operable to determine compliance of one or more individual participants with at least one govemment-required blood-borne pathogens vaccination process.

50. A computer-accessible medium to manage a Hepatitis B virus vaccination process, the computer-accessible medium comprising:
a first performer of a vaccination cycle for a Hepatitis B virus;
a first delayer of about thirty days operably coupled to the first performer;
a second performer of the vaccination cycle for a blood-borne pathogen operably coupled to the first delayer;
a second delayer of about one-hundred-and-eighty days; and
a third performer of the vaccination cycle for the Hepatitis B virus operably coupled to the second delayer;
a third delayer of about thirty days operably coupled to the third performer; and
a manager of finalization of the at least one Hepatitis B virus vaccination process operably coupled to the third delayer.

51. The computer-accessible medium of claim 50, wherein the vaccination cycle for Hepatitis B virus vaccination process further comprises:
a sender of a email reminder to a participant in the Hepatitis B virus vaccination process describing the vaccination;
a determiner of whether or not this vaccination cycle is complete if the fourth email reminder is determined to have been sent;
a receiver of vaccination data if the vaccination cycle is determined to be complete; and
an updater of a record associated with the participant.

52. The computer-accessible medium of claim 50, wherein the computer-accessible medium further comprises:
an enterer of data pertaining to the Hepatitis B virus vaccination process of one or more participants.

53. The computer-accessible medium of claim 52, wherein entering data pertaining to the Hepatitis B virus vaccination process of one or more participants further comprises:
a determiner of data for one of the vaccinations of one of the at least one Hepatitis B virus vaccination process is to be entered;
a receiver of the data; and
a storer of the data in a non-volatile storage medium.

54. A computer data signal embodied in a carrier wave and representing a sequence of instructions which, when executed by a processor, cause the processor to perform the method of:
a first performing of a vaccination cycle for a Hepatitis B virus;
a second performing of the vaccination cycle for a blood-borne pathogen about thirty days after the first performing;
a third performing of the vaccination cycle for the Hepatitis B virus about one-hundred-and-eighty days after the first performing; and
managing finalization of the at least one Hepatitis B virus vaccination process.

55. The computer-data signal of claim 54, wherein the vaccination cycle for a blood-borne pathogen further comprises:
sending an email reminder to a participant in the Hepatitis B virus vaccination process describing the vaccination;
determining whether or not this vaccination cycle is complete if the fourth email reminder is determined to have been sent;
receiving vaccination data if the vaccination cycle is determined to be complete; and
updating a record associated with the participant.

56. A system to transacting in electronic commerce comprising:
a processor;
a storage device coupled to the processor;
software means operative on the processor for:
a first performing of a vaccination cycle for a Hepatitis B virus;
a second performing of the vaccination cycle for a blood-borne pathogen about thirty days after the first performing;
a third performing of the vaccination cycle for the Hepatitis B virus about one-hundred-and-eighty days after the first performing; and
managing finalization of the at least one Hepatitis B virus vaccination process.

57. The system of claim 56, wherein the vaccination cycle for a blood-borne pathogen further comprises:
sending a email reminder to a participant in the Hepatitis B virus vaccination process describing the vaccination;
determining whether or not this vaccination cycle is complete if the fourth email reminder is determined to have been sent;
receiving vaccination data if the vaccination cycle is determined to be complete; and
updating a record associated with the participant.

58. A data structure stored on a computer-readable medium to manage vaccination data of blood-borne pathogens comprising:
a field storing data representing identification of a participant;
a field storing data representing a date of at least one vaccination process of the participant;
a field storing data representing a facility that performed one of the at least one vaccination process;
a field storing data representing a date of at least one blood test of the participant; and
a field storing data representing a facility the performed one of the at least one blood test.

59. The data structure of claim 58, wherein the blood-borne pathogen further comprises:
Hepatitis B virus.

60. The data structure of claim 58, wherein the at least one vaccination process further comprises:
three vaccinations for Hepatitis B virus; and
one titer test.

61. The data structure of claim 58, wherein the at least one vaccination process further consists of:
three vaccinations for Hepatitis B virus; and
one titer test.
